(19) United States
(12) Patent Application Publication
(10) Pub. No.: US 2025/0271651 A1
(43) Pub. Date: Aug. 28, 2025

(54) BIOLOGICAL MICROSCOPY SYSTEM WITH MULTI-FOCAL-PLANE DEPTH SCANNING

(71) Applicant: Optomak, Inc., Quebec (CA)

(72) Inventors: Jean-Luc Néron, Quebec (CA); Harold Dehez, Quebec (CA); Sead Doric, L'Ancienne-Lorette (CA)

(21) Appl. No.: 18/590,486

(22) Filed: Feb. 28, 2024

(51) Int. Cl. G02B 21/00; G02B 21/02; G02B 21/26; G02B 21/36

(52) U.S. Cl. CPC G02B 21/0044; G02B 21/0064; G02B 21/008; G02B 21/02; G02B 21/26; G02B 21/367

(57) ABSTRACT

An optical microscope that rapidly images regions at multiple focal planes of varying depth within a sample provides for study of short-lived processes in biological samples and enhanced scanning throughput over a wide field-of-view (FOV). The microscope includes an image detector, an imaging lens system having one or more lenses disposed in an optical path between the sample and the image detector, a rotating disk disposed within the optical path and having multiple windows of varying optical thickness. Selection between the multiple windows by rotation of the disk varies a depth of images provided by the imaging lens system to the image detector. The microscope also includes a rotational position indicator for generating an indication of a rotational position of the disk. The image data received from the image detector may then be synchronized with the rotational position of the disk to provide a three-dimensional representation of the sample.

### BACKGROUND

### 1. Field of Disclosure

The present disclosure relates generally to biological microscopy systems such as in fluorescence microscope systems, and in particular to a microscopy having multi-focal-plane depth scanning using a rotating disk having apertures with varying optical lengths.

### 2. Background

In biomedical research, in the pharmaceutical industry, and in medicine, organoids, which are miniature versions of an organ that are typically derived from human tissue or stem cells, are used as the subject of biological studies, since they have the same structure and functionality as the particular organ that they mimic. Assembloids, which are three-dimensional (3D) structures incorporating multiple organoids with multiple cell types and spheroids, which are also cellular 3D structures, less complex than organoids, but are also used in the research of drugs and in cell biology, are also the subject of biological studies. In order to observe the internal structure and reactions within the structures of organoids, assembloids, and spheroids. biological microscopy is used, typically involving biological reactions to light stimulus, including fluorescence and/or state changes in a specimen in reaction to the light stimulus.

Imaging of organoids, assembloids, and spheroids is non-trivial, and cannot be performed using typical microscopes. Since typical samples have relatively large dimensions, and are not two dimensional (2D) objects, the samples must be imaged in three dimensions (3D), as 3D imaging is essential for their study. Assembloids, in particular, require sufficient field of view (FOV) of the microscope, due to their size. The above-described biological objects are sometimes imaged using confocal microscopes, with the sample objects scanned not only in a single plane, but also at planes of varying depth. Such scanning is a relatively slow procedure that does not provide a sufficient image frame rate needed for studying short-lived biological processes. Some confocal microscope systems, such as the one disclosed in U.S. Pat. No. 5,717,519, provide an improved scan rate in two dimensions, and optical sectioning of a third dimension by placing multiple pinholes in the light path. However, such microscopes do not provide the rapid focal plane shifting desirable for volumetric imaging. Recently, systems for automated high-speed 3D imaging of organoids based on light-sheet fluorescence microscopy (LSFM) with beam steering have been implemented. LSFM, also referred to as selective plane illumination microscopy (SPIM), also have a relatively slow depth scanning rate, and typically require specific sample containers/chips.

Therefore, it would be desirable to provide a biological microscope system that is capable of rapid volumetric scanning with a large FOV.

### SUMMARY

The above objectives of providing rapid volumetric scanning over a large FOV are accomplished in a method and system that use and implement a multi-focal plane microscope.

The system is a biological microscopy system embodied in an optical microscope that images regions at multiple focal planes of varying depth within a sample, and the method is a method of operation of the microscope. The microscope includes an image detector, an imaging lens system having one or more lenses disposed in an optical path between the sample and the image detector, and a rotating disk disposed within the optical path and having multiple windows of varying optical thickness. Selection between the multiple windows by rotation of the disk varies a depth of images provided by the imaging lens system to the image detector. The microscope also includes a rotational position indicator for generating an indication of a rotational position of the disk.

The summary above is provided for brief explanation and does not restrict the scope of the claims. The description below sets forth example embodiments according to this disclosure. Further embodiments and implementations will be apparent to those having ordinary skill in the art. Persons having ordinary skill in the art will recognize that various equivalent techniques may be applied in lieu of, or in conjunction with, the embodiments discussed below, and all such equivalents are encompassed by the present disclosure.

### BRIEF DESCRIPTION OF THE DRAWINGS

FIG. 1 is a pictorial diagram illustrating an example optical microscope 10, in accordance with an embodiment of the disclosure.

FIG. 2 is a pictorial diagram illustrating a system including example optical microscope 10 of FIG. 1 in combination with an example translation stage 20, in accordance with another embodiment of the disclosure.

FIG. 3 is a block diagram illustrating an example optical microscopy system 30A, in accordance with an embodiment of the disclosure.

FIG. 4 is a pictorial diagram illustrating details of example optical microscope 10 in optical microscopy system 30A of FIG. 3, in accordance with an embodiment of the disclosure.

FIG. 5A is a pictorial diagram illustrating details of an example rotating disk assembly 34A that may be used to implement rotating disk assembly 34 in example microscope 10 in optical microscopy system 30A of FIG. 3, in accordance with an embodiment of the disclosure.

FIG. 5B is a pictorial diagram illustrating details of an example rotating disk assembly 34B that may be used to implement rotating disk assembly 34 in example microscope 10 in optical microscopy system 30A of FIG. 3, in accordance with another embodiment of the disclosure.

FIGS. 6A-6C are pictorial diagrams illustrating operating principles of optical microscope 10, in accordance with another embodiment of the disclosure.

FIG. 7 is a block diagram illustrating another example optical microscopy system 30B, in accordance with another embodiment of the disclosure.

FIG. 8 is a block diagram illustrating another example optical microscopy system 30C, in accordance with another embodiment of the disclosure.

### DETAILED DESCRIPTION OF ILLUSTRATIVE EMBODIMENT

The present disclosure encompasses systems and methods that perform 3D imaging of miniature objects such as organoids, spheroids, brain slices, muscle tissue, and other similar biological structures within a multi-well plate or in a large Petri dish. The system is capable of recording sharp images over a large FOV at a high frame rate, at different depths/focal distances with a high depth resolution relative to the focal length of the objective lens, and the images may be diffraction-limited. In order to perform such observations, the sample may be mounted on a translation stage facilitating large-area imaging and high sample throughput, and may meet criteria such as: sufficient spatial resolution to image each cell individually, a FOV greater than 5 mm, performing imaging of the entire volume of organoids (e.g., 1 mm thickness/depth) by rapid imaging of multiple planes within the organoid, (e.g., 4 or 8 planes), while preserving sample health, i.e., providing low phototoxicity. The system may also meet criteria such as a temporal resolution of 10 Hz for recording cellular activity (e.g., calcium activity), provide an automated motion system for sequential imaging of multiple samples, be integrable within an environmental chamber to maintain samples in a controlled atmosphere, and in a format suitable for laboratory use in, for example, pharmaceutical and medical industry laboratories. The system may provide such features within a single device, in contrast to other systems that may be currently available.

Further, since numerical aperture and FOV of an objective lens are inversely proportional, a typical fluorescent microscope has a smaller FOV at high resolutions and microscopes that deploy tunable lenses to provide imaging at different depths typically do not have sufficient focus adjustment repeatability. The microscopes of the present disclosure also do not require translation of the entire microscope or the sample in order to focus at various depths, which contrasts with bulkier and slower systems that do not provide the features required for the above-described biological experiments. While the systems disclosed herein may meet all of the above requirements, and have applicability in the field of neuroscience and the study of organoids of the nervous system, such applications and features are not limitations of the disclosed system. For example, the system may be a epi-fluorescence microscope employing optogenetic stimulation. The system may also be used for imaging of functional sensors such as calcium sensors or dopamine sensors. The system is capable of observing short-lived biological processes, for example detection of dopamine release, which occurs in a timeframe of less than 1 second, requiring rapid image acquisition over a volume with relatively large cross-sectional area. In other applications, large brain slices may be viewed using the disclosed microscope for examination of functional connectivity. Optogenetic stimulation may also be used to evoke activity in neurons, with optical mapping made possible with the microscopes disclosed herein, which may provide an FOV of a few mm in conjunction with a depth change on the order of a few microns to a few hundred microns.

The disclosed systems are optical microscopes that rapidly image regions at multiple focal planes of varying depth within a sample, providing for study of short-lived processes in biological samples, and enhanced scanning throughput, over a wide field-of-view (FOV). The microscope includes an image detector, an imaging lens system having one or more lenses disposed in an optical path between the sample and the image detector, a rotating disk disposed within the optical path and having multiple windows of varying optical thickness. Selection between the multiple windows by rotation of the disk varies a depth of images provided by the imaging lens system to the image detector. The microscope also includes a rotational position indicator for generating an indication of a rotational position of the disk. The images may be synchronized by a control system coupled to the rotational position indicator and the image detector to provide a three-dimensional representation of the sample. In contrast to existing microscopy systems, for example, in classical light sheet microscopy, the disclosed microscope systems provide the ability to scan a volume across a large area, which is particularly useful when the sample is in a large Petri dish, or when there are multiple samples distributed in, for example, a multi-well plate. A computer-controlled translation stage may move the sample holder or microscope in at least some of the x, y or z directions. By providing the above features, it is possible to have automated scanning over the larger area, or scan multiple imaging regions. The computer program may control the translation stage to move the sample (or microscope) in a predefined sequence of acquisition, and obtaining a high image throughput. Translation stages offer high repeatability with respect to position of the sample relative to the microscope. The translation stage may be programmed to follow a predefined movement, or to be controlled by software that finds contours, shapes, features or objects of interest in real time, and image the objects according to an algorithm, providing image data for analysis. The disclosed systems may implement volumetric growth tracking or sphericity estimation of organoids or assembloids, for example.

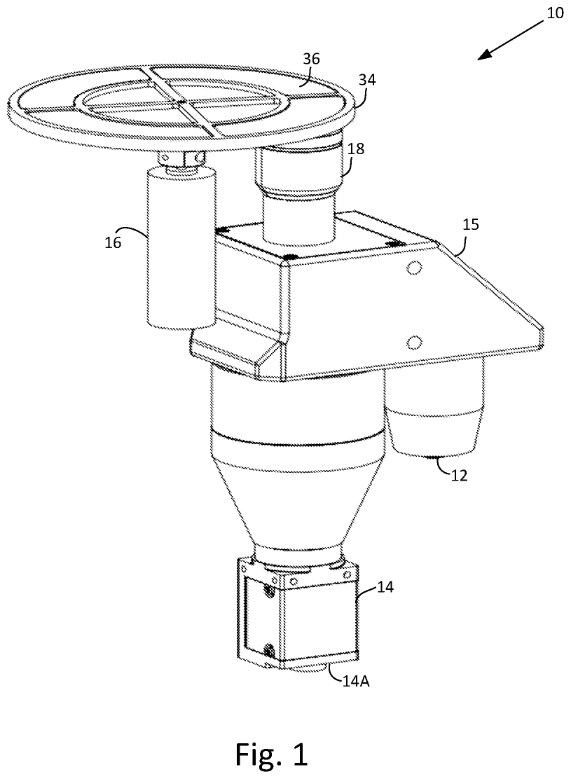

Referring now to FIG. 1, a pictorial diagram illustrating an example optical microscope 10 is shown, in accordance with an embodiment of the disclosure. Example optical microscope 10 has a large FOV and is capable of rapid and fine variation in working distance. A fiber port 12 provides for introduction of illumination light from an external illumination source via an optical fiber or light guide (not shown). An imaging subsystem 14 includes an image sensor 14A that provides for capture of image data as a rotating disk that includes plates 36 of varying optical lengths is rotated by a motor 16. In depicted example microscope 10, rotating disk 34 is positioned between a sample (not shown) and an objective lens assembly 18, but rotating disk 34 may be positioned in other locations, or multiple rotating disks may be provided in other embodiments of the disclosure. In the depicted system of example microscope 10, the illumination light provided through fiber port 12 induces fluorescence in the sample, the fluorescence light returning from the sample passes back through objective lens assembly 18, e.g., through a tube lens of objective lens assembly 18, and is focused onto image sensor 14A. By including rotating disk 34 with, for example, multiple glass windows to implement plates 36 of different optical thicknesses, the focal plane is shifted and effectively scans the sample in depth or z-direction, i.e., at different internal planes passing through the sample.

Resolution of an optical microscope may be limited by several factors. Example microscope 10 is suitable for use in for viewing mesoscopic objects with sizes comparable to millimeters, thereby requiring only low levels of magnification. For cellular imaging, the resolution in the scanning planes that pass through the sample, i.e., the x-y resolution, is approximately 2-3 um. With a large FOV of a few millimeters, image sensor 14A chip may require high pixel resolution, and with a pixel pitch that is small enough to provide an imager/camera chip/die size that is reasonable. For smaller pixel sizes, the required exposure time increases in order to provide a reasonable signal-to-noise ratio (SNR), which limits the frame rate of microscope 10. With a magnification of 2×-5×, and a pixel size of a few microns square, the system operates close to diffraction limits. Using readily available camera sensor dies at present, which have high definition (HD) or ultra-high definition (UHD) pixel arrays, e.g., arrays with a resolution of up to 3840×2160, facilitates a large FOV. Limitations in the frame rate of microscope 10 may arise due to data transfer speed limitations imposed by various protocols, however, protocols such as Camera Link protocol may render interface speed limitations irrelevant. Other more commonly-used protocols such as universal serial bus (USB) protocols, if used in the disclosed embodiments may impose limitations on the frame rate of microscope 10.

In example microscope 10, image acquisition is synchronized with the rotational position of rotating disk 34. The angular position of disk 34 is encoded by a rotational encoder, which may be an optical, magnetic, electromechanical encoder, or other suitable encoder. To avoid any contact with disk 34, the encoder may use a set of magnets on the disk perimeter, with static Hall-effect sensors mounted on a housing of microscope 10 close to disk 34 detecting the presence of the magnets as they pass by the sensors. The rotational encoder also be optical or of other type of rotational encoder as mentioned above, from which the angular position of disk 34, relative or absolute, is detected with sufficient resolution to synchronize image acquisition by image sensor 14A. Synchronization of the image acquisition with the disk position ensures that the images are captured when returning light is passing through a single one of plates 36 and without distortion by any of the edges of plates 36, i.e., each image is taken at a specific depth plane in the sample selected by the optical thickness of a corresponding plate 36, and to maximize the image integration time at image sensor 14.

In some embodiments, the illumination is synchronized with the image acquisition, e.g., providing illumination only during image integration by enabling/disabling the illumination, either by power control of the source, interruption of illumination by a shutter, or redirection of illumination by a reflector, or other suitable mechanism for interrupting the illumination of the sample. The illumination of the sample, i.e., the sample exposure time may be controlled. The intensity of the excitation light may be modulated to provide the greatest intensity during image capture, reducing/eliminating detrimental effects on the sample and potentially improving SNR and/or increasing the frame rate of the images, as less time may be required needed for frame capture. The modulation or other control of illumination intensity may be an important consideration when it is desirable to capture a large number of image planes at a high frame-rate, as increasing the number of plates 36 in rotating disk 34 windows decreases available per-image integration time of image sensor 14A. Detection of the angular position of rotating disk 34 may also be used to provide feedback control for maintaining a rotation rate of rotating disk 34. For example, an angular encoder measuring the rotation of rotating disk 34 may provide a feedback signal for proportional integral-derivative (PID) control loop that controls motor 16 to maintain a set angular speed of the spinning disk. The encoder provides speed information, making it possible to stabilize the speed at a desired value, and make precision adjustment to the angular speed of rotating disk 34, if required. The same encoder may be used for rotational control and for camera synchronization; alternatively separate encoders specialized for their particular purpose may be used.

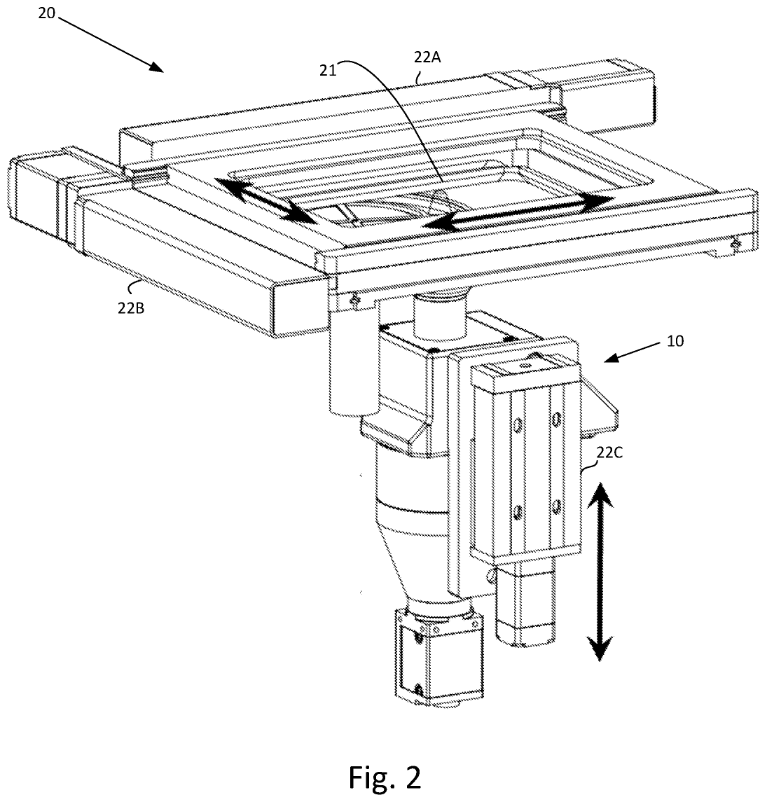

FIG. 2 is a pictorial diagram illustrating a system including example optical microscope 10 of FIG. 1 in combination with an example translation stage 20, in accordance with another embodiment of the disclosure. Translation stage 20 moves a sample 21 relative to microscope 10 in at least one dimension. In the depicted embodiment, x and y translation stages 22A, 22B move sample 21, and a z-direction translation stage 22C moves microscope 10 in a direction perpendicular to that of translation stages 22A,22B, which is a same direction as that provided by the depth-scanning features of microscope 10 provided by rotating disk 34. While the depicted system is an example of a three-axis positioned microscopy system, such example is not limiting. For example, z-axis translation stage 22C may be omitted when microscope 10 is referenced to a fixed sample container, yielding a two-axis translation system, and/or one of translation stages 22A, 22B may be omitted when sample 21 is moved along a track that is static in the corresponding axis and microscope 10 referenced to a linear array of samples in a linear arrangement of sample wells, yielding another two-axis translation system. Further, while the illustrated system translates sample 21 with respect to microscope 10 in two axes (x,y) and translates microscope 10 in one axis (z) with respect to sample 21, it is understood that microscope 10 may be translated with respect to sample 21, or microscope 10 may be translated in one or more axes and sample 21 translated in others, in accordance with various alternative embodiments of the disclosure. Translation stages 22A-22C are computer-controlled, and may be programmed to expose and focus on samples contained in a multi-well plate. The stages may also be programmed to scan a larger sample (like a brain slice or other tissue), according to a pre-defined route. In some embodiments, microscope 10 is translated in some or all of the x, y and z directions, while the sample 21 is stationary, which may be desirable when minimal mechanical impact on the sample is needed, since moving sample 21 may shake or stir its contents. The above-described implementation is desirable if it is not practical or possible to move the sample, or when the sample is hermetically encapsulated in an enclosure that cannot be moved on a translation stage. While the above embodiments have been described generally with reference to Cartesian translations, it is understood that sample 21 and/or microscope 10 may be moved in rotation or in other directions, for example sample 21 may be rotated while still allowing depth adjustment of either sample 21 or microscope 10 in the z direction. The above-described embodiments may be particularly useful if sample 21 is provided in a drum-shaped tray. The design of translation stages 22A-22C may therefore be adapted to the sample tray design and vary accordingly, and such variations are contemplated as being within the scope of the present disclosure.

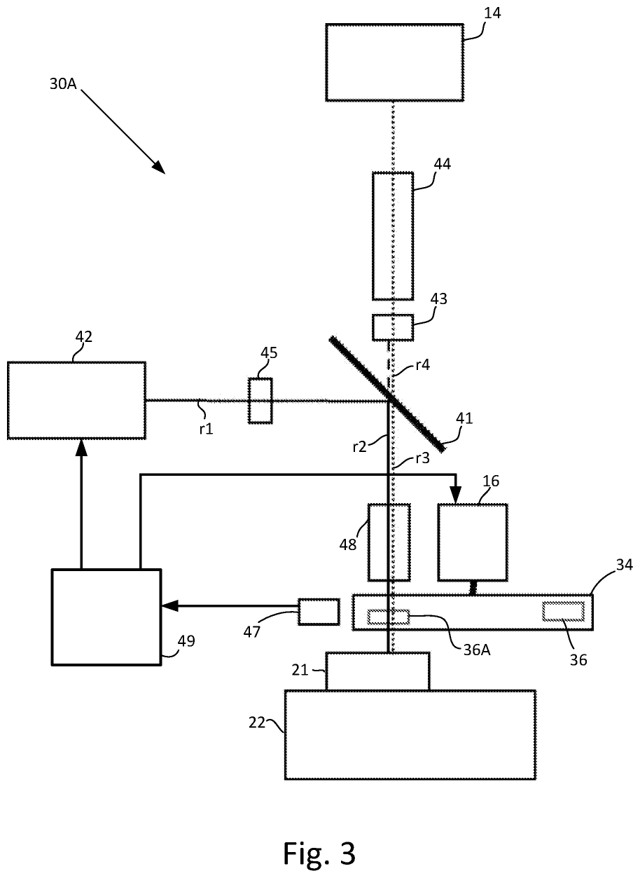

Referring now to FIG. 3, a block diagram illustrating an example optical microscopy system 30A is shown, in accordance with an embodiment of the disclosure. Excitation light r1 from an illumination subsystem 42 is collimated, filtered and focused on the back focal plane of the objective of an objective lens assembly 48 to illuminate sample 21 through objective lens assembly 18 and rotating disk 34. Light r3 emitted from sample 21 passes through a plate 36A of rotating disk 34, objective lens assembly 18, a dichroic splitter 41, an emission filter 43, and a tube lens 44, before reaching imaging subsystem 14 as separated and filtered image light r4. Imaging subsystem is coupled to computer 49 for capture of images of the planes within sample 21 selected by plates 36 of rotating disk 34. Sample 21 is mounted on translation stage 22 controlled by computer 49, and exposes a portion of a larger profile of sample 21 to an excitation beam r2 provided from illumination subsystem 42. Position and/or angular velocity information is provided by encoder 47, which is coupled to computer 49. Illumination subsystem 42 is also coupled to computer 49 and includes a light source that may be monochromatic or polychromatic, i.e., color illumination. It is also possible to illuminate/excite the observed region of sample 21 with multiple light sources, thereby, for example, imaging multiple fluorescing species within a single sample. With color illumination, the exact excitation spectrum is determined by the characteristics of an excitation filter 45 placed in the path of the collimated excitation light provided from illumination subsystem 42. Excitation filter 45 may be interchangeable and it may pass/transmit one or multiple wavelength bands. Multi-color imaging may be achieved by interleaved illumination provided from illumination subsystem 42 in conjunction with a single image sensor/camera within imaging subsystem 14, with a consequence of possible reduction in frame rate per color. Alternatively, a multitude of image sensors, areas of a single sensor, or multiple cameras may be used, with at least partial simultaneous multi-chroic illumination provided from illumination subsystem 42. Achromatic optics may be used to avoid differences in plane depth at the different illumination/response wavelengths.

In one embodiment, illumination source 42 may be integrated within microscope 10, which maximizes the stability and efficiency of the illumination, and simplifying synchronization of the illumination with the rotation of rotating disk 34 and imaging subsystem 14. In another embodiment, an external illumination source 42 may be connected to microscope 10 via, e.g., an optical fiber port, such as illumination port 12 in FIG. 1, facilitating flexibility in the selection of provided illumination. It is also contemplated that a device operator may define and control the timing and spatial distribution of the illumination to follow a predefined pattern, or to adapt the illumination in real time according to the imaged scenery. Control of the illumination may also include patterning the illumination. Employing well-known techniques from structured illumination microscopy, in particular spatially modulated illumination, in which multiple images at the same focal plane are collected and combined, deblurring and improved optical sectioning may be obtained. Another application of the microscope systems disclosed herein is within the field of optogenetics. Simultaneously with imaging planes within sample 21, optogenetic stimulation may be applied to sample 21, which may be, for example, a large brain slice. The stimulation of neurons may be imposed through objective lens system 48 and may stimulate areas of interest within the imaged region of sample 21 at the focal plane selected by the position of rotating disk 34. The stimulated cells are marked with genetically encoded light sensitive ion channels (e.g., channelrhodopsine, halorhodopsine, etc.) so that the stimulus light controls their activity. Fluorescence imaging of the fluorescent proteins performed via microscope 10 then provides monitoring of cell activity.

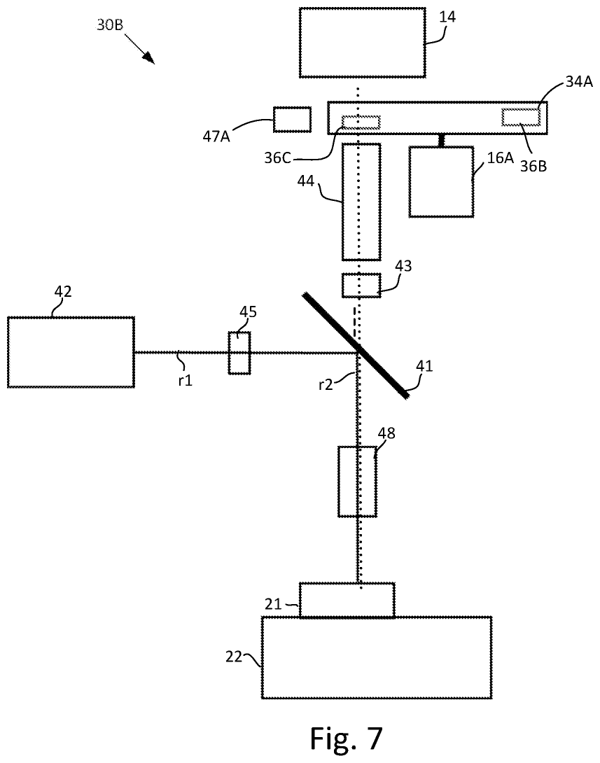

Depending on the implementation, either simultaneous or sequential stimulation may be performed with respect to the imaging performed by imaging subsystem 14. In such an implementation, x-y translation may be used to select a portion of a sample that may be relatively much larger, and translation in z direction together with the selection of plates 36 of rotating disk 34 provide auto-focusing of the image of the sample. In the above-described configuration, rotating disk may be stationary and actively modulating the focal plane, but rather may be moved to a static position once the desired depth of sample 21 is in focus. In other embodiments, as described below with reference to FIG. 7, if rotating disk 34 is re-located to a position between tube lens 44 and imaging subsystem 14, multi-focus recording may still be performed, with the optogenetic stimulation provided at a fixed depth-plane as the stimulus light does not pass through the plates 36 of rotating disk 14. In the above-described embodiment, the distance between objective lens system 18 and sample 21 may be reduced. In order to reduce or prevent cross-talk between the different optical modalities (e.g., the combination of fluorescence imaging with optogenetic stimulation), the illumination light of each modality may be spectrally and/or spatially distinct. In the systems described herein, the excitation source may be external and interchangeable so that two or more excitation lights, i.e., illumination sources, may be coupled to the system, e.g., by one or more additional optical fiber ports.

The microscopy systems described herein are suitable for viewing objects with sizes comparable to millimeters. The magnification in one example embodiment is fixed at between 2.2×-3× and the desired FOV is 5 mm×5 mm. A USB camera with 2.3 megapixel (Mp) resolution (1900×1200) and a pixel pitch of 5.8 μm may be used with a magnification of 2.2×, yielding a pixel size at the sample of approximately 2.7 μm. The described arrangement is slightly greater than the diffraction limit, which is approximately 2 μm, in the instant case. The FOV in the instant case is approximately 5 mm×3.5 mm. With a 16 Mp camera, (4000×4000 pixels), a 3 μm pitch, and a magnification of 3×, the pixel size at the sample is 1 μm and the resolution of the system is limited by the diffraction limit of about 2 μm. Another data transfer protocol such as GigE or Camera Link may enable higher image resolution without a consequent reduced frame rate. Camera Link is capable of supporting UHD resolution with higher FOV and camera frame rate that there is no reduction from a desired frame rate of 80 frames per second. Ultimately, CoaXPress12, or CXP12, protocol may alternatively be used, which will enable very high frame throughput.

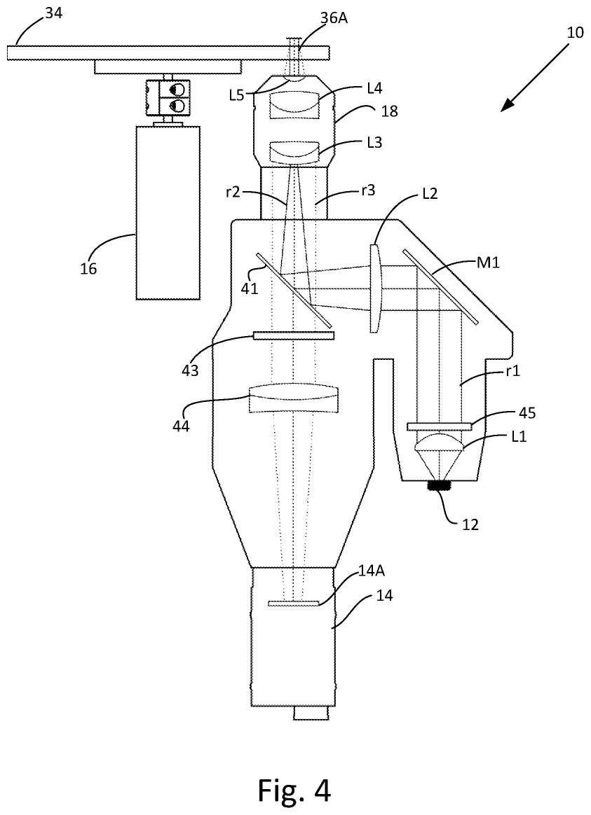

Referring now to FIG. 4, a pictorial diagram illustrating details of example optical microscope 10 in optical microscopy system 30A of FIG. 3 is shown, in accordance with an embodiment of the disclosure. As described above with reference to FIG. 3, example optical microscope includes rotating disk 34, and other optical components that permit excitation of a sample and imaging of planes within the sample. FIG. 4 shows optical paths within example optical microscope 10. A fiber-coupled illumination port 12 provides introduction of illumination light into example optical microscope 10, which is collimated by one or more collimating lenses L1, filtered by excitation filter 45 (which may be interchangeable), and directed by a mirror M1 to dichroic splitter 41. A focusing lens L2 focuses illumination light r1 before reaching dichroic splitter 41. Motor 16 rotates rotating disk 34 at a controlled angular velocity facilitating imaging at 5 Hz and above. Rotating disk 34 may have an encoder reporting a position of rotating disk (not shown) so that synchronization with image sensor 14A, e.g., camera, within imaging subsystem 14 is enabled. Mirror M1 directs the excitation light r2 into objective lens assembly 18 and through one of plates 36A of rotating disk 34 to a sample tray placed on an x-y translation stage (not shown). For fluorescence microscopy applications, focusing lens L2 focuses the excitation light at the back focal plane of the objective lens assembly 18, ensuring uniform Kohler illumination at the sample, as illustrated. For optogenetic, the light is collimated at the back focal plane of objective lens assembly 18, and the excitation light is focused at the imaging plane. In some embodiments, lens L2 is omitted entirely. Light r3 emitted from the sample passes back through the same plate 36 of rotating disk 34 and through objective lens assembly 18, which, in the example, includes one or more lenses L3, L4, and L5 forming an objective lens, and then through one or more lenses making up a tube lens 44. Dichroic splitter 41 passes the emission light through an interchangeable emission filter 43 that filters the emission light, which then passes through tube lens 44. Tube lens 44 focuses the image plane selected by plate 36A of rotating disk 34 on image sensor 18A of imaging subsystem 18, which records diffraction-limited images produced by microscope 10.

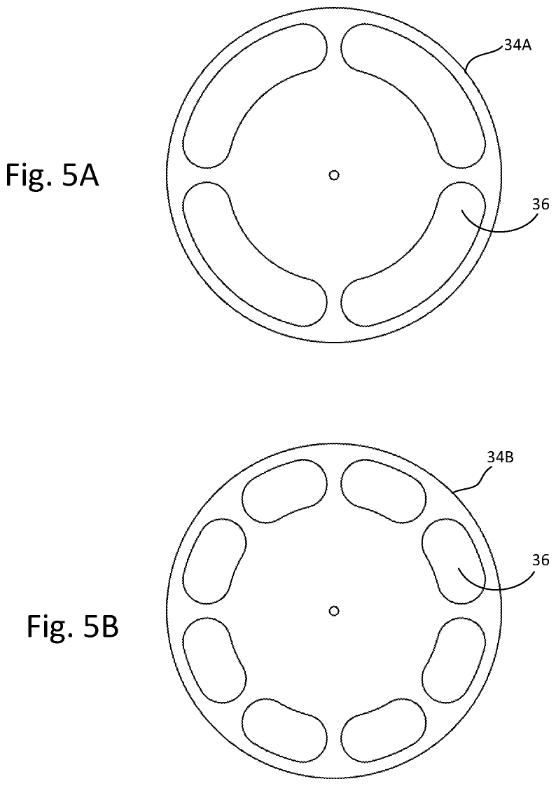

Motor 16 spins rotating disk 34 at a pre-defined angular speed, typically 5 to 20 rotations per second (300 rpm to 1200 rpm). Synchronizing the disk position and image acquisition is facilitated by the angular position encoder, which as mentioned above, may be constructed with magnets and one or more Hall-effect sensors. Magnets may be placed close to the disk, while the Hall-effect sensor may be fixedly mounted inside the microscope enclosure. The above-described arrangement provides a simple and contactless position detection or positioning system, depending on whether rotating disk 34 is spun, or is rotated between fixed rotational positions. Image acquisition by image sensor 14A is synchronous with the disk position, and frames are recorded through the plates 36 of rotating disk 34, i.e., at the specific depth plane(s) in the sample as selected by the plate 36A that is currently within the optical paths of example microscope system, 10. In normal operation, rotating disk 34 rotates at 10 rotations per second (or 600 rpm) to image a 3D volume within the sample at 10 Hz. Rotating disk 34 may be interchangeable and may have, for example, four or eight windows, as depicted in FIGS. 5A-5B. The above described example embodiment will have a frame rate of 10×4=40 or 10×8=80 frames per second depending on the particular example rotating disk used in example optical microscope 10. In an example embodiment, plates 36 are windows made of identical material (BK7) and have different thicknesses.

Referring now to FIG. 5A, a pictorial diagram illustrating details of an example rotating disk assembly 34A that may be used to implement rotating disk assembly 34 in example microscope 10 in optical microscopy system 30A of FIG. 3 is shown, in accordance with an embodiment of the disclosure. Rotating disk assembly 34A is an example of a four-plate disk with plates 36A-36D of different optical thicknesses provided to shift the depth of the focal plane of microscope 10 as different ones of plates 36A-36D are either statically positioned within the objective optical path of microscope 10, or dynamically rotated, with synchronization to the image sensor captures. Plates 36A-36D will generally be of different mechanical thicknesses, but alternatively, or in combination, may be of different refractive indices (n), so that the optical path length differs as between plates 36A-36D at least in part due to the material of plates 36A-36D. Plates 36A-36D may be rectangular prisms. Referring now to FIG. 5B, a pictorial diagram illustrating details of another example rotating disk assembly 34B that may be used to implement rotating disk assembly 34 in example microscope 10 in optical microscopy system 30A of FIG. 3 is shown, in accordance with another embodiment of the disclosure. Rotating disk assembly 34B is an example of a rotating disk assembly having eight plates 36, which doubles the number of planes that are imaged for a given rotational rate of rotating disk assembly 34B, while reducing available integration time and consequent SNR. Alternatively, rotating disk assembly 34B is rotated at a lower rotation rate to maintain the integration time/SNR at the same level as rotating disk assembly 34A.

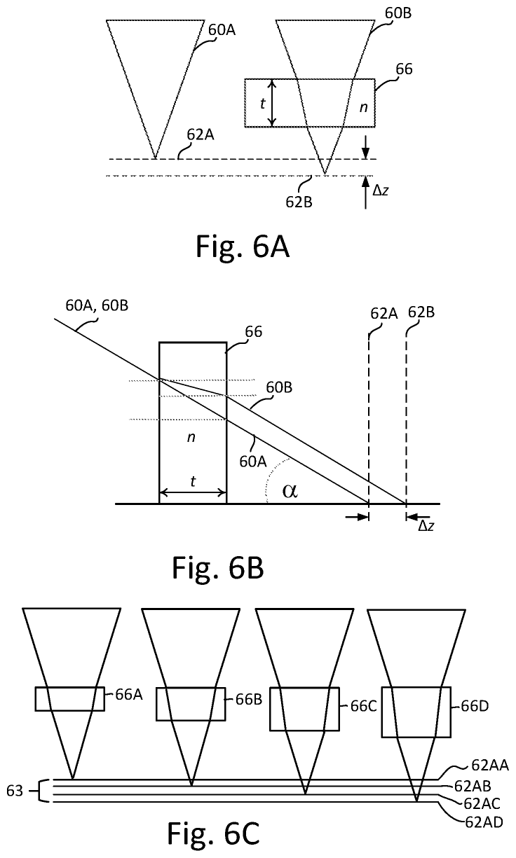

Referring now to FIGS. 6A-6C, pictorial diagrams illustrating operating principles of optical microscope 10 are shown, in accordance with another embodiment of the disclosure. FIG. 6A illustrates a result of inserting a plate 66 having plane-parallel surfaces and a refractive index n that is greater than the refractive index of the surroundings, e.g., air, within the optical imaging path of microscope 10. On the left-hand side of FIG. 6A, a focusing beam 60A that does not pass through the plate 66 has a resultant focal plane 62A at a position close to the focusing lens/objective (not shown). When plate 66 is inserted into the path of the focusing beam 60B, a new focal plane 62B is established, which is shifted by a distance Δz relative to the original focal plane 62A. The amount of z-direction shift depends on the optical thickness of the plate 66, and is a function of the physical thickness d and the refractive index n of the optic. FIG. 6B illustrates the shift in focusing beam 60A from focal plane 62A to focal plane 62B when plate 66 is inserted to the optical imaging path to produce shifted beam 60B. The shift Δz is equal to t*(n−1)/n, according to Snell's law, in which thickness t and Δz are shown in FIG. 6B. FIG. 6C shows a focusing beam 60 with plates 66A-66D of different thickness (or alternatively optical thickness changes due to material changes of plates 66A-66D) inserted into the optical imaging path of microscope 10. The shift 63 of focal planes 62AA-62DD in the z-direction due to the differences in thickness of plates 66A-66D is illustrated, along with the narrowing of focusing beam 60.

FIG. 7 is a block diagram illustrating another example optical microscopy system 30B, in accordance with another embodiment of the disclosure. In the above-described example embodiments, rotating disk 34 is positioned between objective lens system 18 and sample 21, which, for optogenetic stimulation applications, provides for automatic and simultaneous focusing of the excitation light at the same plane from which the image is recorded, as long as the chromatic aberration of objective lens system 18 is not significantly great. In fluorescence microscopy applications, with Kohler illumination, the excitation light is collimated at the output of objective lens system 18 instead. In accordance with other example embodiments, a rotating disk 34A may be located between imaging subsystem 18 and tube lens 44, and rotated by a motor 16A to that an active plate 36C is selected by rotation of rotating disk 34A, as in optical microscopy system 30B. A sensor 47A, is provided to determine a position of, and optionally regulate the rotation rate of rotating disk 34A. The location of a rotating disk 34A between imaging subsystem 18 and tube lens 44 permits shorter distances between sample 21 and the objective lens system 18. However, such a configuration may introduce difficulty in providing the required window thicknesses/optical path distance of plates 36B of rotating disk 34A.

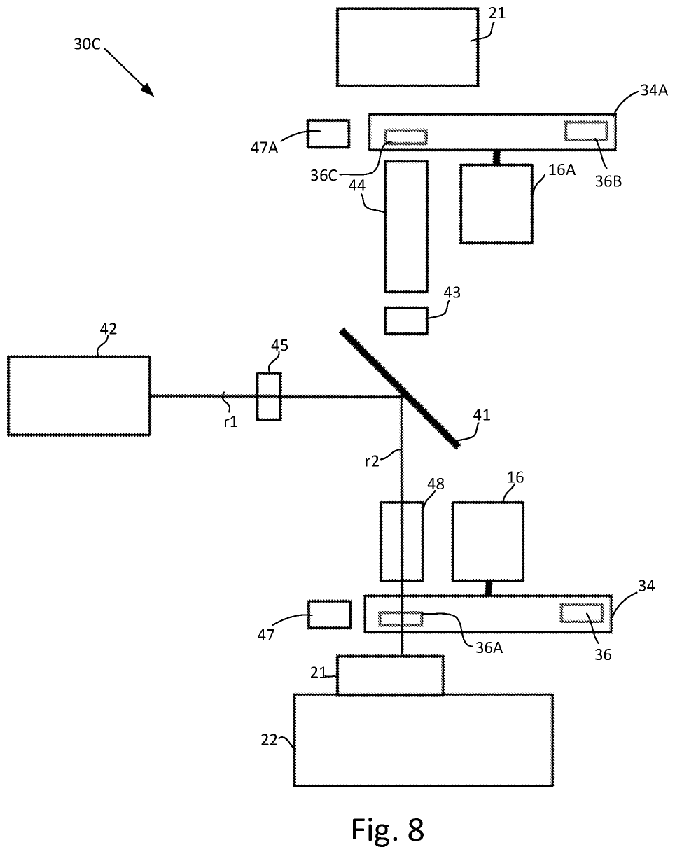

FIG. 8 is a block diagram illustrating another example optical microscopy system 30C, in accordance with another embodiment of the disclosure. In optical microscopy system 30C, a configuration with two or more rotating disks 34, 34A having different rotation rates set by motors 16, 16A is presented, which results in the number of imaged planes being potentially increased to a product of the number of windows in each disk, i.e., the total number of possible window combinations. The multiple disks may be collocated in either of the locations described above, or one disk may be provided between sample 21 and objective lens system 48, while the other rotating disk is located between imaging subsystem 18 and tube lens 44, as illustrated in example optical microscopy system 30C, which combines the components associated with rotating disk 34 in microscopy system 30A of FIG. 3 with the components associated with rotating disk 34A in microscopy system 30B of FIG. 7.

In summary, the instant disclosure discloses a method and system embodied in a microscope and microscopy system that image regions at multiple focal planes of varying depth within a sample. The microscope may include an image detector, an imaging lens system having one or more lenses disposed in an optical path between the sample and the image detector, and a rotating disk disposed within the optical path and having multiple windows of varying optical thickness. Selection between the multiple windows may be accomplished by rotation of the disk to vary a depth of images provided by the imaging lens system to the image detector. The system also includes a rotational position indicator for generating an indication of a rotational position of the disk.

The system may include a control system coupled to an output of the image detector and the rotational position indicator that synchronizes image data received from the image detector with the rotational position of the rotating disk to produce a three-dimensional representation of the sample. In some example embodiments, the one or more lenses of the imaging lens system may include an objective lens that couples light returned from the sample through the objective lens, and a tube lens that receives the light from the objective lens and focuses the light on the image detector. In some example embodiments, the rotating disk may be disposed along the optical path between the sample and the objective lens. In other example embodiments, the rotating disk may be disposed between the tube lens and the image detector.

In some example embodiments, the rotating disk is a first rotating disk and the system may include a second rotating disk having multiple windows of varying optical thickness disposed along the optical path. Selection between the multiple windows of the first disk and the second disk, in combination, may be made by rotation of the first disk and the second disk, which varies the depth of the image provided by the imaging lens system to the image detector. In some example embodiments, the first disk and the second disk may be collocated between either the sample and the objective lens or between the tube lens and the image detector. In some example embodiments, the first disk may be disposed between the sample and the objective lens, and the second disk may be disposed between the image detector and the tube lens.

In some example embodiments, a translation stage for moving the imaging lens system or the sample with respect to each other in a plane orthogonal to the axis of rotation of the rotating disk may be included. In some example embodiments, the translation stage may be coupled to the control system to position the translation stage, and the control system may move the imaging lens system or the samples to multiple predefined positions defined with respect to a multi-well sample plate or a Petri dish. In some example embodiments, a three-axis translation stage may be included for moving the imaging lens system or the sample with respect to each other, and which may adjust the position of the focal planes imaged by the rotating disk to the sample. In some example embodiments, the illumination may not pass through the windows of the rotating disk, and the translation stage may move the imaging lens system with respect to the sample, for example, to focus the illumination on the sample for optogenetic stimulation applications, while the rotating disk provides imaging of multiple depths within the sample. In some example embodiments, a rate of selection between the multiple windows by rotation of the disk is 5 Hz or greater.

In some example embodiments, the microscope may include an illumination system for providing illumination to the sample, and a dichroic splitter that directs the illumination from the illumination system to the sample through an objective lens of the one or more lenses of the imaging lens system. The dichroic splitter may couple light returned from the sample through the objective lens through the imaging lens system to the image detector. In some example embodiments the illumination system may be coupled to the control system and may be synchronized with the rotational position of the rotating disk. In some example embodiments, the control system may modulate an intensity of the illumination system in synchronization with the rotational position of the rotating disk. In some example embodiments, the multiple windows of varying optical thickness are arranged out-of-order of the optical thickness to at least partially mechanically balance the rotation of the rotating disk. In some example embodiments, the imaging lens system may include a movable lens or a tunable liquid lens to statically adjust the optical length of the optical path between the sample and the image detector to adjust a baseline depth of the image provided by the imaging lens system to the image detector, independent of the variation of the depth provided by the rotating disk.

While the disclosure has shown and described particular embodiments of the techniques disclosed herein, it will be understood by those skilled in the art that the foregoing and other changes in form, and details may be made therein without departing from the spirit and scope of the disclosure. For example, the techniques shown above may be applied to microscopes for other applications in which a scannable focal depth is desired.

What is claimed is:

1. A microscope for imaging regions at multiple focal planes of varying depth within a sample, the microscope comprising:
an image detector;
an imaging lens system having one or more lenses disposed in an optical path between the sample and the image detector;
a rotating disk disposed within the optical path and having multiple windows of varying optical thickness, wherein selection between the multiple windows by rotation of the disk varies a depth of images provided by the imaging lens system to the image detector; and
a rotational position indicator for generating an indication of a rotational position of the disk.

2. The microscope of claim 1, further comprising a control system coupled to an output of the image detector and the rotational position indicator that synchronizes image data received from the image detector with the rotational position of the rotating disk to produce a three-dimensional representation of the sample.

3. The microscope of claim 1, wherein the one or more lenses of the imaging lens system comprises:
an objective lens that couples light returned from the sample through the objective lens; and
a tube lens that receives the light from the objective lens and focuses the light on the image detector.

4. The microscope of claim 3, wherein the rotating disk is disposed along the optical path between the sample and the objective lens.

5. The microscope of claim 3, wherein the rotating disk is disposed between the tube lens and the image detector.

6. The microscope of claim 3, wherein the rotating disk is a first rotating disk and further comprising a second rotating disk having multiple windows of varying optical thickness disposed along the optical path, wherein selection between the multiple windows of the first disk and the second disk, in combination, by rotation of the first disk and the second disk, varies the depth of the image provided by the imaging lens system to the image detector.

7. The microscope of claim 6, wherein the first disk and the second disk are collocated between either the sample and the objective lens or between the tube lens and the image detector.

8. The microscope of claim 6, wherein the first disk is disposed between the sample and the objective lens, and wherein the second disk is disposed between the image detector and the tube lens.

9. The microscope of claim 1, further comprising a translation stage for moving the imaging lens system or the sample with respect to each other in a plane orthogonal to an axis of rotation of the rotating disk.

10. The microscope of claim 9, further comprising a control system coupled to an output of the image detector and the rotational position indicator that synchronizes image data received from the image detector with the rotational position of the rotating disk to produce a three-dimensional representation of the sample, wherein the translation stage is coupled to the control system to position the translation stage, and wherein the control system moves the imaging lens system or the samples to multiple predefined positions defined with respect to a multi-well sample plate or a Petri dish.

11. The microscope of claim 1, further comprising three-axis translation stage for moving the imaging lens system or the sample with respect to each other and for adjusting the position of the focal planes imaged by the rotating disk to the sample.

12. The microscope of claim 11, wherein the illumination does not pass through the windows of the rotating disk, and wherein the translation stage moves the imaging lens system with respect to the sample to focus the illumination on the sample while the rotating disk provides imaging of multiple depths within the sample.

13. The microscope of claim 1, wherein a rate of selection between the multiple windows by rotation of the disk is 5 Hz or greater.

14. The microscope of claim 1, further comprising:
an illumination system for providing illumination to the sample; and
a dichroic splitter that directs the illumination from the illumination system to the sample through an objective lens of the one or more lenses of the imaging lens system, wherein the dichroic splitter couples light returned from the sample through the objective lens through the imaging lens system to the image detector.

15. The microscope of claim 13, further comprising a control system coupled to an output of the image detector and the rotational position indicator that synchronizes image data received from the image detector with the rotational position of the rotating disk to produce a three-dimensional representation of the sample, wherein the illumination system is coupled to the control system and synchronized with the rotational position of the rotating disk.

16. The microscope of claim 15, wherein the control system modulates an intensity of the illumination system in synchronization with the rotational position of the rotating disk.

17. The microscope of claim 1, wherein the multiple windows of varying optical thickness are arranged out-of-order of the optical thickness to at least partially mechanically balance the rotation of the rotating disk.

18. The microscope of claim 1, wherein the imaging lens system includes a movable lens or a tunable liquid lens to statically adjust the optical length of the optical path between the sample and the image detector to adjust a baseline depth of the image provided by the imaging lens system to the image detector, independent of the variation of the depth provided by the rotating disk.

19. A method of imaging regions at multiple focal planes of varying depth within a sample, comprising:
imaging the regions with an imaging lens system having one or more lenses disposed in an optical path between the sample and an image detector;
rotating a disk disposed within the optical path and having multiple windows of varying optical thickness to select between the multiple windows to vary a depth of images provided by the imaging lens system to the image detector;
determining a rotational position of the disk with a rotational position indicator; and
detecting light returning or emanating from the regions with the imaging detector to provide image data.

20. The method of claim 19, further comprising synchronizing the image data with the rotational position of the rotating disk to produce a three-dimensional representation of the sample.

21. The method of claim 18, further comprising:
coupling light returned from the sample through an objective lens of the imaging lens system; and
receiving the light from the objective lens and focusing the light on the image detector with a tube lens.

22. The method of claim 21, further comprising positioning the rotating disk along the optical path between the sample and the objective lens.

23. The method of claim 21, further comprising positioning the rotating disk between the tube lens and the image detector.

24. The method of claim 21, wherein the rotating disk is a first rotating disk, and wherein the method further comprises:
positioning a second rotating disk having multiple windows of varying optical thickness in the optical path; and
selecting between the multiple windows of the first disk and the second disk, in combination, by rotation of the first disk and the second disk, to vary the depth of the image provided by the imaging lens system to the image detector.

25. The method of claim 24, further comprising collocating the first disk and the second disk between either the sample and the objective lens or between the tube lens and the image detector.

26. The method of claim 24, further comprising:
positioning the first disk between the sample and the objective lens; and
positioning the second disk between the image detector and the tube lens.

27. The method of claim 19, further comprising for moving the imaging lens system or the sample with respect to each other in a plane orthogonal to an axis of rotation of the rotating disk with a translation stage.

28. The method of claim 27, further comprising:
synchronizing image data received from the image detector with the rotational position of the rotating disk to produce a three-dimensional representation of the sample; and
positioning the translation stage by moving the imaging lens system or the samples to multiple predefined positions defined with respect to a multi-well sample plate or a Petri dish.

29. The method of claim 19, further comprising moving the imaging lens system or the sample with respect to each other and adjusting the position of the focal planes imaged by the rotating disk to the sample with a three-axis translation stage.

30. The method of claim 29, wherein the illumination does not pass through the windows of the rotating disk, and wherein the translation stage moves the imaging lens system with respect to the sample to focus the illumination on the sample while the rotating disk provides imaging of multiple depths within the sample.

31. The method of claim 19, wherein a rate of selection between the multiple windows by rotation of the disk is 5 Hz or greater.

32. The method of claim 19, further comprising:
providing illumination to the sample from an illumination system;
directing the illumination from the illumination system to the sample through an objective lens of the one or more lenses of the imaging lens system with a dichroic splitter; and
coupling light returned from the sample through the objective lens through the imaging lens system to the image detector through the dichroic splitter.

33. The method of claim 31, further comprising:
synchronizing image data received from the image detector with the rotational position of the rotating disk to produce a three-dimensional representation of the sample; and
synchronizing the illumination system with the rotational position of the rotating disk.

34. The method of claim 33, further comprising modulating an intensity of the illumination system in synchronization with the rotational position of the rotating disk.

35. The method of claim 19, further comprising at least partially mechanically balancing the rotation of the rotating disk by arranging the multiple windows of varying optical thickness out-of-order of their optical thickness.

36. The method of claim 19, further comprising statically adjusting the optical length of the optical path between the sample and the image detector to adjust a baseline depth of the image provided by the imaging lens system to the image detector, independent of the variation of the depth provided by the rotating disk with a movable lens or a tunable liquid lens.
